(19) United States
(12) Patent Application Publication
(10) Pub. No.: US 2002/0101971 A1
(43) Pub. Date: Aug. 1, 2002

(54) Method , system, and server for providing internet call waiting service

(76) Inventors: Peng Zhang, Buffalo Grove, IL (US); Lun Xiong He, Lisle, IL (US); Bing Leng, Naperville, IL (US); ZhongJin Yang, Naperville, IL (US)

Correspondence Address: Lucent Technologies Inc., Docket Administrator (Rm. 3C-512), 600 Mountain Avenue, P.O. Box 636, Murray Hill, NJ, 07974-0636, US

(21) Appl. No.: 09/772,832

(22) Filed: Jan. 30, 2001

(51) Int. Cl. H04M 3/42

(52) U.S. Cl. 379/215.01

(57) ABSTRACT

The present invention provides a method, communication system, and Internet Call Waiting/Holding (ICW/H) server for providing internet call waiting service without dropping the connection between a computer and an Internet Service Provider (ISP). A computer, via a modem or the like, initiates an internet call waiting connection between the computer and the ISP via a switch. The ISP assigns a dynamic Internet Protocol (IP) address to the computer for the internet call waiting connection. The computer sends the directory number and the dynamic IP address of the computer to an Internet Call Waiting/Holding (ICW/H) server, which stores them. The ICW/H server sends a message to the switch indicating that the call waiting service is active. The switch, upon receiving an incoming call request intended for the computer while the internet call waiting connection is active, routes the incoming call request to the ICW/H server. The ICW/H server alerts the computer of the incoming call request without dropping the internet call waiting connection.

### FIELD OF THE INVENTION

The present invention relates generally to communication systems, and more particularly to providing call waiting service to computers connected to the Internet.

### BACKGROUND OF THE INVENTION

Call waiting is a feature offered by local exchange carriers that signals a user when an incoming call is received during a call in progress. The indication to the user is typically in the form of a click or other audible noise.

There are occasions when the interruption of the call in progress by a call waiting indication is not desired. One such instance is when the user does not want the call in progress to be interrupted, such as when involved in a long-distance call or a very important call.

A second instance when a user may not want a call waiting indication is when the user is utilizing a modem and connected to an internet service provider (ISP). Receiving a call waiting indication can interrupt the connection between the computer and the ISP to such an extent that the connection between the ISP and the computer is dropped. In this scenario, the user has to redial the ISP to reestablish the connection between the computer and the ISP. This can be greatly inconvenient when the user is in the midst of utilizing the ISP.

One method used to alleviate this problem is the temporary disabling of the call waiting feature. In this approach, a predefined key sequence, *70, is dialed before dialing the phone number of the ISP. This predefined key sequence disables the call waiting feature for the length of this call. If a call comes in to the phone line to which the computer is connected while this connection to the ISP is ongoing, the caller will receive either a busy signal or will be directed to the voice mailbox of the user if the user has subscribed to the voice mail service.

Although this solution alleviates the problem of dropped connections to ISPs due to call waiting interruptions of incoming calls, it prevents the user from being notified of incoming calls while connected to the ISP. This prevents the user from receiving these calls if desired.

Therefore, a need exists for a way to receive an indication of incoming call to a user connected to an ISP without dropping the connection with the ISP.

### SUMMARY OF THE INVENTION

It is an object of the present invention to provide a method, communication system, and server that facilitates internet call waiting service. The communication system includes a switch, an Internet Service Provider (ISP), and an Internet Call Waiting/Holding (ICW/H) server.

A computer, utilizing a modem and a phone line, initiates an internet call waiting connection with an ISP. The internet call waiting connection traverses a switch. This is preferably done by dialing an access code, such as *90, before the directory number of the ISP to enable the internet call waiting service.

The ISP assigns a dynamic Internet Protocol (IP) address to the computer, which is used for the internet call waiting connection. The computer sends the directory number of the phone line that the computer is utilizing and the dynamic IP address of the computer to the Internet Call Waiting/Holding (ICW/H) server.

The ICW/H server stores the directory number and the dynamic IP address of the computer and sends a message to the switch indicating that the call waiting service is active for this internet call waiting connection. The switch stores this information so that when a call request is received for the phone line to which the computer is connected, it will know how to direct the call. The ICW/H server is notified by the computer when the internet call waiting connection terminates, and will remove the IP address and directory number of the computer from its memory. After the computer releases the connection to the ISP, the switch will remove the indication that an internet call waiting connection is in progress.

When the switch receives, during the internet call waiting connection, an incoming call request intended for the computer, the switch routes the incoming call request to the ICW/H server. The switch will know that the phone line connected to the computer is involved in an internet call waiting connection based upon the completion message received from the ICW/H server.

The ICW/H server, upon receiving the incoming call request from the switch, alerts the computer of the incoming call request without dropping the internet call waiting connection. This is preferably done by presenting the computer with a choice as to whether to accept the incoming call request.

If the computer accepts the incoming call request, the internet call waiting connection is maintained. The computer can switch back to the internet call waiting connection from the incoming call request. If desired, the user of the computer can accept the call and terminate the internet call waiting connection.

Thus, the present invention provides a method, communication system, and server for providing internet call waiting service.

### BRIEF DESCRIPTION OF THE DRAWINGS

FIG. 1 depicts a communication system including an Internet Call Waiting/Holding (ICW/H) server in accordance with the present invention.

FIG. 2 depicts the Internet Call Waiting/Holding (ICW/H) server of FIG. 1 in more detail in accordance with the present invention.

FIG. 3 depicts a flowchart of a method for providing call waiting service to a user connected to an internet service provider in accordance with the present invention.

### DESCRIPTION OF THE PREFERRED EMBODIMENT(S)

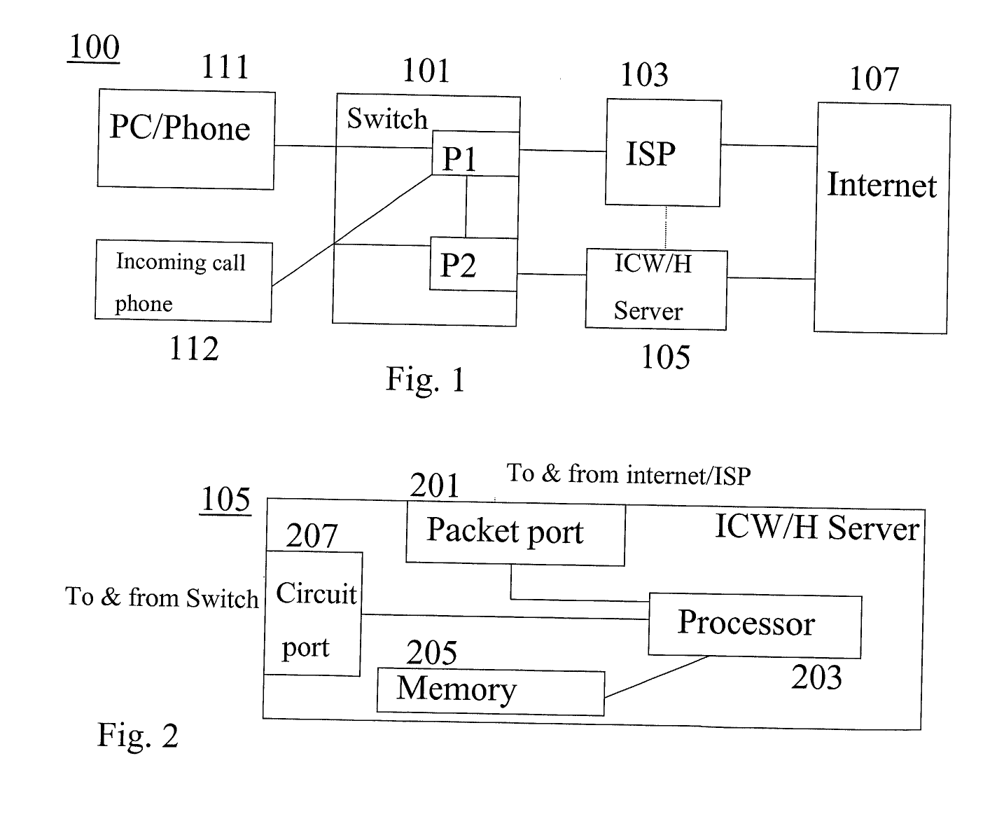

FIG. 1 depicts a communication system 100 for providing internet call waiting service. Communication system 100 includes a switch 101, an Internet Service Provider (ISP) 103, and an Internet Call Waiting/Holding (ICW/H) server 105. Communication system 100 is preferably coupled to the Internet 107, which is the common name for a loose confederation of autonomous networks that are interconnected via TCP/IP (Transmission Control Protocol/Internet Protocol), an open protocol suite in the public domain. Internet 107 is a worldwide, distributed, interconnected group of individual computers and networks.

Switch 101 is a device that connects to Customer Premises Equipment (CPE) and provides access to a Public Switched Telephone Network (PSTN). The PSTN provides public telephone switching service. FIG. 1 depicts two CPEs connected to switch 101, a personal computer (PC) 111 and a calling phone 112. PC 111 includes a modem and has access to a telephone line to access switch 101. In the preferred embodiment of the present invention, switch 101 is a “5ESS” switching system provided by “LUCENT TECHNOLOGIES INC.” of Murray Hill, N.J.

Switch 101 receives a request for an internet call waiting connection from a computer attempting to access Internet 107 via ISP 103. The request includes a predefined key sequence, such as *90, that indicates that this is a request for an internet call waiting connection.

ISP 103 is coupled to switch 101 and provides access to Internet 107. ISP 103 is effective in assigning a dynamic Internet Protocol (IP) address to computer 111 for the connection.

Computer 111 sends the directory number and the dynamic IP address of computer 111 to ICW/H server 105. ICW/H server 105 is coupled to switch 101 and ISP 103. ICW/H server 105 receives the directory number and the dynamic IP address of computer 111 from computer 111. ICW/H server 105 stores the directory number and the dynamic IP address of computer 111. Upon receiving the directory number and dynamic IP address of computer 111, ICW/H server 105 sends a message to switch 101 indicating that the call waiting service is active for computer 111.

Subsequent to the internet call waiting connection being established, switch 101 receives an incoming call request intended for computer 111. Switch 101 checks to determine if the intended directory number is currently involved in an internet call waiting connection. Switch 101 performs this by checking the list of currently active internet call waiting connections that is created each time a phone line begins an internet call waiting connection. Switch 101 routes the incoming call request to ICW/H server 105.

If ICW/H server 105 determines that the incoming call request should be displayed to computer 111, ICW/H server 105 alerts computer 111 of the incoming call request without dropping the internet call waiting connection.

FIG. 2 depicts the Internet Call Waiting/Holding (ICW/H) server 105 of FIG. 1 in more detail in accordance with the present invention. ICW/H server 105 includes a packet port 201, a processor 203, memory 205, and a circuit port 207.

Packet port 201 receives the directory number and the dynamic IP address of the computer requesting internet call waiting service from the computer. The directory number and the dynamic IP address are associated with the computer for an internet call waiting connection. Processor 203 sends a message via circuit port 207 to the switch indicating that the internet call waiting service is active. The directory number and the dynamic IP address of the computer are stored in memory 205.

Circuit port 207 is effective in receiving an incoming call request from the switch. This incoming call request occurs while the computer is still connected to the ISP via the internet call waiting connection.

Upon receiving the incoming call request from the switch, processor 203 checks memory 205 to obtain the directory number and the dynamic IP address for the internet call waiting connection of the computer. The internet call waiting service is preferably indexed by directory number, so that processor 203 will look in memory 205 by the directory number of the incoming call request. Processor 203 sends an alerting message, via packet port 201, that includes the directory number of the incoming caller to the computer.

Circuit port 207 is also effective in sending a message to the switch requesting the switch to establish the necessary call bridging functionality as required.

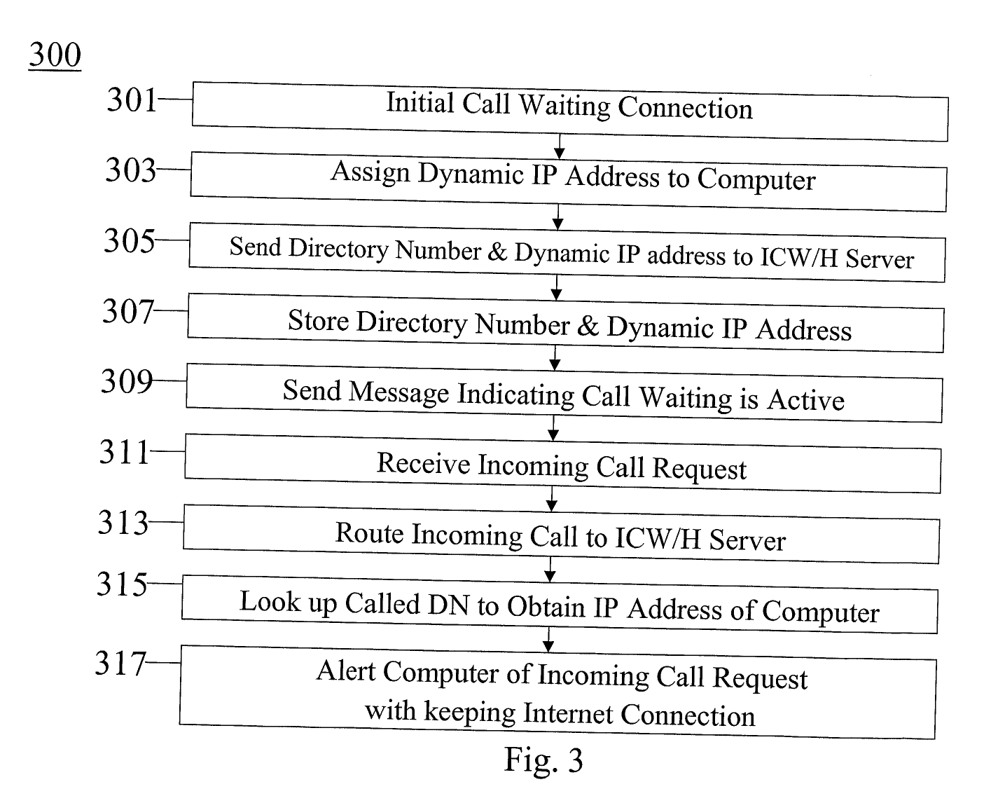

FIG. 3 depicts a flowchart 300 of a method for providing call waiting service to a user connected to an internet service provider without dropping the connection with the ISP in accordance with the present invention.

A computer initiates (301) an internet call waiting connection with an ISP. The internet call waiting connection preferably comprises a predefined key sequence, such as *90, followed by the directory number of the ISP. The internet call waiting connection traverses a switch, which recognizes the predefined key sequence as an indication that this is a request for an internet call waiting connection.

The ISP assigns (303) a dynamic Internet Protocol (IP) address to the computer for the internet call waiting connection. The IP address is a 32-bit address assigned to uniquely identify this computer on the Internet. The ISP will assign a dynamic IP address, which is an address that is assigned for the duration of a connection, but which can be reassigned to a different computer upon termination of the connection with the first computer.

Upon receiving the dynamic IP address, the computer sends (305) the directory number and the dynamic IP address of the computer to the Internet Call Waiting/Holding (ICW/H) server. The directory number is associated with the phone line to which the computer is connected, while the IP address is preferably dynamic. The dynamic IP address can change for every distinct connection that the computer has to the ISP.

The ICW/H server stores (307) the directory number and the dynamic IP address of the computer in memory located at the ICW/H server. The table in which this information is stored is preferably indexed by the directory number, so that when a call request later comes in for this directory number the ICW/H server can quickly access the stored information.

The ICW/H server sends (309) a message to the switch indicating that the call waiting service is active. The switch will store the status of this connection. Until this message is received, the switch does not know whether the internet call waiting connection has been successfully established. This could be the case if the ISP is down or is currently out of dynamic IP addresses to assign. Until the switch receives the message indicating that the call waiting service is active, the switch will assume that partial internet call waiting service is enabled.

The switch receives (311) an incoming call request intended for the computer while the internet call waiting connection is active. The switch will check the stored status of this connection to determine if the called directory number has an internet call waiting connection currently active. If the line is in the partial call waiting service state, the calling party is directed to a message that states that the party is currently involved in an internet connection and cannot take the call.

If the internet call waiting connection has been successfully established, the switch routes (313) the incoming call request to the ICW/H server. The ICW/H server looks up (315) the called directory number to obtain the dynamic IP address of the computer.

The ICW/H server alerts (317) the computer of the incoming call request without dropping the internet call waiting connection. In the preferred embodiment of the present invention, the step of alerting the computer of the incoming call comprises presenting the computer with a choice as to whether to accept the incoming call request. This is preferably accomplishing by sending a series of data packets to the computer. The data packets are received by the computer and, utilizing a graphical user interface, displayed on the computer in such a manner as to alert the user of the incoming call request and to present the user with a series of options that the user can take in response to this call request.

If the computer accepts the incoming call request, the internet call waiting connection is preferably maintained. The computer can switch back to the internet call waiting connection from the incoming call request. The user can also decide to accept the incoming call request and drop the internet call waiting connection.

The user of the computer can alternately reject the incoming call request. In this case, the user can completely reject the incoming call, send a message to the calling party, play a prerecorded message, or send the user to the voice mailbox associated with their directory number. If the user completely rejects the oncoming call, the caller will receive a busy signal. The message sent to the caller would preferably be a text message typed by the user of the computer on the computer. The text message could then with be sent to the user and displayed on the screen of the caller, or could be sent to a test-to-speech converter, which converts the typed text to speech and conveys the speech to the caller. The prerecorded message can be either recorded by the user or can be provided by the system. The message would preferably inform the caller that the user is currently connected to the Internet and the caller should attempt to call back at a later time.

Thus, the present invention provides a method, communication system, and server that solve a problem associated with the prior art. The present invention provides a method, communication system, and internet call waiting and holding server for providing an internet call waiting service.

The present invention provides numerous advantages over the prior art. A user using a computer and a modem that is connected to an ISP can receive indications of incoming calls. The user can then decide whether to accept the call, reject the call, send a message to the caller, or play a prerecorded message to the caller. This all occurs without dropping the connection between the computer and the ISP. If the user decides to accept the call, the connection between the computer and the ISP can be maintained. Thus, when the user is done speaking to the caller, the user can resume his connection with the ISP without having to redial the ISP.

While this invention has been described in terms of certain examples thereof, it is not intended that it be limited to the above description, but rather only to the extent set forth in the claims that follow.

We claim:

1. A method for providing call waiting service for a computer connected to an Internet Service Provider (ISP) without dropping the connection with the ISP, the method comprising:
initiating an internet call waiting connection between the computer and an ISP, the internet call waiting connection traversing a switch;
sending the directory number and a dynamic IP address of the computer to an Internet Call Waiting/Holding (ICW/H) server;
storing the directory number and the dynamic IP address of the computer at the ICW/H server; and
sending a message from the ICW/H server to the switch indicating that the call waiting service is active.

2. A method for providing call waiting service in accordance with claim 1, the method further comprising the steps of:
receiving an incoming call request intended for the computer at the switch while the internet call waiting connection is active;
routing the incoming call request from the switch to the ICW/H server; and
alerting the computer of the incoming call request without dropping the internet call waiting connection.

3. A method for providing call waiting service in accordance with claim 2, wherein the step of alerting the computer of the incoming call request is performed by the ICW/H server via the internet call waiting connection.

4. A method for providing call waiting service in accordance with claim 2, wherein step of alerting the computer of the incoming call comprises presenting the computer with a choice as to whether to accept the incoming call request.

5. A method for providing call waiting service in accordance with claim 4, further comprising step of maintaining the internet call waiting connection if the computer accepts the incoming call request.

6. A method for providing call waiting service in accordance with claim 5, further comprising the step of switching back to the internet call waiting connection after the incoming call releases.

7. A method for providing call waiting service in accordance with claim 4, the method further comprising the step of dropping the internet call waiting connection.

8. A method for providing call waiting service in accordance with claim 4, the method further comprising the step of rejecting the incoming call request.

9. A method for providing call waiting service in accordance with claim 8, wherein the step of rejecting the incoming call request comprises playing a prerecorded message.

10. A method for providing call waiting service in accordance with claim 8, wherein the step of rejecting the incoming call request comprises sending a message to the phone associated with the incoming call request.

11. A method for providing call waiting service in accordance with claim 10, wherein the message is a packet-based message.

12. A method for providing call waiting service in accordance with claim 10, further comprising the step of converting the message utilizing a test-to-speech converter.

13. A method for providing call waiting service in accordance with claim 1, wherein the step of initiating an internet call waiting connection between the computer and an ISP comprises dialing an access code to enable the internet call waiting service.

14. An internet call waiting system comprising:
a switch for receiving a request for an internet call waiting connection from a computer;
an Internet Service Provider (ISP) coupled to the switch and providing access to the Internet, the ISP effective in assigning a dynamic Internet Protocol (IP) address to the computer for the internet call waiting connection to the internet; and
an Internet Call Waiting/Holding (ICW/H) server coupled to the switch and the ISP, the ICW/H server effective in receiving and storing the directory number and the dynamic IP address of the computer, the ICW/H server also effective in sending a message to the switch indicating that the call waiting service is active.

15. An internet call waiting system in accordance with claim 14, wherein the switch is effective in performing internet call waiting registration.

16. An internet call waiting system in accordance with claim 15, wherein the switch is effective in completing the internet call waiting registration based upon receipt of a confirmation from the ICW/H server.

17. An internet call waiting system in accordance with claim 14, wherein the switch is effective in receiving an incoming call request intended for the computer while the internet call waiting connection is active.

18. An internet call waiting system in accordance with claim 17, wherein the switch is effective in routing the incoming call request to the ICW/H server.

19. An internet call waiting system in accordance with claim 18, wherein the switch is effective in releasing the internet call waiting connection and bridging a connection between a computer and an incoming call.

20. An internet call waiting system in accordance with claim 18, wherein the switch is effective in maintaining the internet call waiting connection and bridging a connection between a computer and an incoming call.

21. An internet call waiting system in accordance with claim 20, wherein the switch is effective in releasing the connection between the computer and the incoming call and reactivating the internet call waiting connection between the computer and the ISP.

22. An internet call waiting system in accordance with claim 21, wherein the switch is effective in deactivating the internet call waiting connection.

23. An internet call waiting system in accordance with claim 18, wherein the ICW/H server is effective in receiving a message including the directory number and dynamic IP address of the computer to the ISP.

24. An internet call waiting system in accordance with claim 23, wherein the ICW/H server is effective in alerting the computer of the incoming call request without dropping the internet call waiting connection.

25. An internet call waiting system in accordance with claim 23, wherein the ICW/H server is effective in deactivating the internet call waiting connection.

26. An Internet Call Waiting/Holding (ICW/H) server comprising:
a packet port for receiving a directory number and a dynamic IP address of a computer, the directory number and the dynamic IP address associated with a computer for an internet call waiting connection;
memory for storing the directory number and the dynamic IP address of the computer;
a processor; and
a circuit port for sending a message to a switch indicating that call waiting service is active.

27. An Internet Call Waiting/Holding (ICW/H) server in accordance with claim 26, wherein the circuit port is effective in receiving an incoming call request from the switch.

28. An Internet Call Waiting/Holding (ICW/H) server in accordance with claim 27, wherein the processor is effective in sending an alerting message including the directory number of an incoming caller to the computer.

29. An Internet Call Waiting/Holding (ICW/H) server in accordance with claim 27, wherein the processor is effective in sending a message via the circuit port to the switch for instructing the switch to perform call bridging functionality.
